(19) United States
(12) Patent Application Publication
(10) Pub. No.: US 2011/0174398 A1
(43) Pub. Date: Jul. 21, 2011

(54) VALVE APPARATUS TO PREVENT CONTAMINATION OF FLUID IN A FLUID REGULATOR

(76) Inventors: Jason David Clifford, Brooklyn Park, MN (US); Mark Wharton Cramer, Zimmerman, MN (US)

(21) Appl. No.: 13/052,470

(22) Filed: Mar. 21, 2011

Related U.S. Application Data
(63) Continuation-in-part of application No. 12/496,868, filed on Jul. 2, 2009.

(51) Int. Cl. B01D 35/02; F16K 51/00

(52) U.S. Cl. 137/549

(57) ABSTRACT

Valve apparatus to prevent contamination of a fluid in a fluid regulator are described. An example valve apparatus described herein includes a housing disposed within a fluid flow passageway of the fluid regulator to define a low-pressure side of the fluid flow passageway and a high-pressure side of the fluid flow passageway. The housing has a bore that at least partially defines the fluid flow passageway when coupled to the fluid regulator. The housing has a movable valve assembly disposed within the bore via a non-threaded connection in fluid communication with the low-pressure side of the fluid flow passageway and external threads to threadably couple the housing to an opening of the fluid regulator. A seal system prevents impurities from flowing between the high-pressure side of the fluid flow passageway and the low-pressure side of the fluid flow passageway.

### CROSS-REFERENCE TO RELATED APPLICATIONS

This patent arises as a continuation-in-part of U.S. patent application Ser. No. 12/496,868, filed on Jul. 2, 2009, entitled “BALANCED VALVE CARTRIDGE,” which is incorporated herein by reference in its entirety.

### FIELD OF THE DISCLOSURE

This patent relates generally to fluid regulators and, more particularly, to valve apparatus to prevent contamination of a fluid in a fluid regulator.

### BACKGROUND

Fluid regulators are commonly distributed throughout process control systems to control the pressures of various fluids (e.g., liquids, gasses, etc.). Fluid regulators are typically used to regulate the pressure of a fluid to a substantially constant value. Specifically, a fluid regulator has an inlet that typically receives a supply fluid at a relatively high pressure and provides a relatively lower and substantially constant pressure at an outlet.

To regulate the downstream pressure, fluids regulators commonly include a sensing element or diaphragm to sense an outlet pressure in fluid communication with a downstream source. A valve apparatus is disposed within the fluid flow passageway to control or modulate fluid flow between an inlet and the outlet. The valve apparatus is operatively coupled to the sensing element, which causes the valve apparatus to move between an open position to allow fluid flow between the inlet and the outlet and a closed position to prevent or restrict fluid flow between the inlet and the outlet based on a pressure differential across the sensing element.

To couple the valve apparatus in the fluid flow passageway, some known fluid regulators employ a retainer or other member that is threadably coupled to a bore of the fluid regulator body. However, during assembly, such a threaded connection may form impurities (e.g., particulate, debris or contaminate) downstream from a filter of the valve apparatus. In operation, a high pressure process fluid may cause impurities to flow in the fluid flow passageway and contaminate downstream components or equipment. For high-purity applications, a contaminated fluid may be unacceptable. Additionally or alternatively, impurities may settle on a sealing surface of the valve apparatus, which may cause an improper seal when the fluid regulator is in a closed position and/or cause damage to the valve apparatus.

### SUMMARY

In one example, a valve apparatus includes a housing disposed within a fluid flow passageway of the fluid regulator to define a low-pressure side of the fluid flow passageway and a high-pressure side of the fluid flow passageway. The housing has a bore that at least partially defines the fluid flow passageway when coupled to the fluid regulator. The housing has a movable valve assembly disposed within the bore via a non-threaded connection in fluid communication with the low-pressure side of the fluid flow passageway and external threads to threadably couple the housing to an opening of the fluid regulator. A seal system prevents impurities from flowing between the high-pressure side of the fluid flow passageway and the low-pressure side of the fluid flow passageway.

In another example, a fluid regulator includes a valve body having a threaded opening that at least partially defines a fluid flow passageway between an inlet and an outlet. The fluid regulator includes a valve cartridge having a housing that includes external threads to removably couple the valve cartridge to the threaded opening of the valve body and the valve cartridge has a filter coupled to the housing. The housing has a bore to receive a flow control assembly such that the flow control assembly is coupled to the housing via a non-threaded connection downstream from the filter. A seal is coupled to the housing of the valve cartridge and the seal is positioned between the external threads of the valve cartridge and a sensing chamber of the fluid regulator to prevent impurities from contaminating a process fluid downstream of the filter where the seal and the filter isolate impurities within the opening of the fluid regulator upstream from the filter.

### BRIEF DESCRIPTION OF THE DRAWINGS

FIG. 1 illustrates a known fluid regulator.

FIG. 2 illustrates an enlarged view of a known valve apparatus that may be used to implement the known fluid regulator of FIG. 1

FIG. 3 illustrates an example fluid regulator described herein.

FIG. 4 is an enlarged view of a portion of the example fluid regulator of FIG. 3.

FIG. 5 illustrates a partial view of a fluid regulator having another example valve apparatus described herein.

FIG. 6 illustrates a partial view of a fluid regulator having yet another example valve apparatus described herein.

### DETAILED DESCRIPTION

Example valve apparatus described herein significantly reduce or prevent impurities (e.g., contaminate, debris, particulate, etc.) from flowing to downstream components or equipment and/or from accumulating on sealing surfaces of the valve apparatus. More specifically, the example valve apparatus described herein may have external threads to removably couple the valve apparatus to a fluid regulator body. When coupled to the fluid regulator body, the valve apparatus defines a low-pressure side of a fluid flow passageway and a high-pressure side of the fluid flow passageway and may include a movable valve member to control the fluid flow between the low-pressure side and the high-pressure side of the passageway. Unlike conventional or known valve apparatus, the valve apparatus described herein employ a seal system to prevent impurities from flowing between the high-pressure side of the fluid flow passageway and the low-pressure side of the fluid flow passageway. In other words, the seal system may prevent impurities from flowing in a filtered portion of the fluid flow passageway of the fluid regulator. In some examples, a seal system may include a seal disposed on a low pressure side of the external threads of the valve apparatus. For example, a seal may be disposed between external threads of the valve apparatus and a sensing chamber of the fluid regulator to prevent impurities from flowing in a fluid flow passageway via the sensing chamber. Thus, the example seal prevents fluid communication between the external threads of the valve assembly and the fluid flow passageway.

Additionally, in some examples, the seal system of the valve apparatus may include a filter disposed in the fluid flow passageway such that the external threads are disposed between the filter and the seal. In this manner, the example seal and filter prevent impurities from flowing in the fluid flow passageway. In particular, the example filter and the seal isolate or trap impurities (e.g., impurities produced by the external threads) upstream from the filter and prevent such impurities from flowing in the fluid flow passageway and/or accumulating on a valve seat or fluid control apparatus. Thus, the example filter and the seal trap or contain any impurities upstream of the filter.

Further, unlike conventional fluid regulators, the valve apparatus of the illustrated example retains a movable flow control assembly within a bore of the valve apparatus via a non-threaded connection. In other words, the example valve apparatus described herein do not have threaded connections downstream from the filter or a filtered-side of the fluid flow passageway. Thus, the non-threaded connection further reduces the likelihood of contamination of the process fluid downstream from the filter.

In yet other examples, an example seal system of a valve apparatus may have a first seal (e.g., an O-ring) disposed adjacent a first side of the external threads of the valve apparatus (i.e., the low-pressure side of the passageway) and a second seal (e.g., an O-ring) disposed adjacent a second side of the external threads (i.e., the high-pressure side of the passageway). In this manner, the example first and second seals capture impurities between the external threads that may be produced during assembly of the fluid regulator.

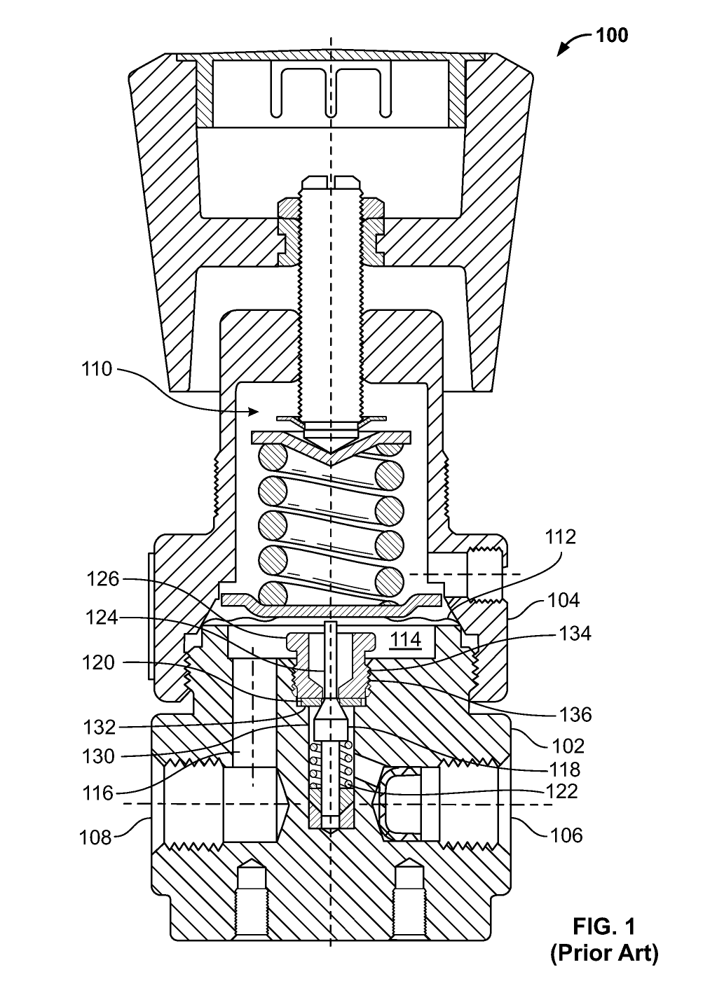

Before discussing an example fluid regulator described herein, a brief description of a known fluid regulator 100 is provided in FIG. 1. Referring to FIG. 1, the example fluid regulator 100 includes a valve body 102 threadably coupled to a bonnet 104 that defines a fluid passageway between an inlet 106 and an outlet 108. A load assembly 110 is disposed within the bonnet 104 to provide a load to a diaphragm 112, where the load corresponds to a desired fluid outlet pressure. The diaphragm 112 is captured between the bonnet 104 and the valve body 102 such that the diaphragm 112 and the valve body 102 define a sensing chamber 114 that is in fluid communication with the outlet 108 via a passageway 116.

A valve apparatus or poppet 118 moves relative to a valve seat 120 to regulate or modulate fluid flow between the inlet 106 and the outlet 108. A biasing element 122 biases the poppet 118 toward the valve seat 120. The poppet 118 also includes a stem 124 to operatively couple the diaphragm 112 and the poppet 118. A retainer 126 retains the valve seat 120 and the poppet 118 within a bore 130 of the valve body 102.

During assembly, the biasing element 122 and the poppet 118 are disposed within the bore 130. The valve seat 120 is disposed within the bore 130 and supported on a shoulder 132 of the bore 130. The retainer 126 is threadably coupled to the bore 130 of the valve body 102. The retainer 126 has a cylindrical body that includes external threads 134 to engage threads 136 of the valve body 102. However, during assembly, the threads 134 of the retainer 126 and/or the threads 136 of the valve body 102, whether plated or un-plated with a coating material, may cause or produce impurities (e.g., contaminate, particulate or debris). For example, during assembly, crowns of the threads 134, 136 may have burrs (e.g., that may be formed during machining of the threads 134, 136) that break-off or produce metal particles or shavings as the threads 134, 136 engage or rotate relative to each other. In some instances, in high pressure applications or pressure cycling applications that produce pressure pulses, a process fluid may cause the impurities or particulate to agitate and flow in the sensing chamber 114, thereby contaminating the process fluid flowing through the fluid flow passageway 116 and contaminating downstream components or equipment.

Additionally or alternatively, the impurities or particulate may flow or accumulate on the valve seat 120 and/or the poppet 118, thereby preventing a tight seal as the poppet 118 engages the valve seat 120 when the fluid regulator 100 is in a closed position. Additionally, accumulation of impurities on the valve seat 120 and/or the poppet 118 may cause damage to the poppet 118 and/or the valve seat 120, thereby reducing the operational life of the poppet 118 and/or the valve seat 120.

The threads 134 of the retainer 126 and the threads 136 of the valve body 102 are typically straight threads so that the retainer 126 can be accurately positioned relative to the valve body 102 and the diaphragm 112. However, because the threads 134, 136 are straight threads, high pressure fluid from the inlet 106 may flow between the threads 134, 136 to the sensing chamber 114, thereby causing impurities to flow in the fluid flow passageway. Further, some known fluid regulators may include a seal disposed below the threads 134, 136 on the inlet side 106 of the fluid flow passageway. However, vibration and/or pressure pulses across the fluid flow passageway may agitate debris or impurities between the threads 134, 136, causing the impurities to flow into the fluid flow passageway via the sensing chamber 114. In some instances, the orientation of the fluid regulator 100 may be such that gravity and/or vibration causes debris or impurities between the threads 134, 136 to flow into the fluid flow passageway. For example, if the fluid regulator 100 is oriented upside down, impurities between the threads 134, 136 may fall into the sensing chamber 114 due to gravity and/or vibration.

Further, although an NPT thread engagement can provide a seal between the engaging threads, an NPT thread instead of the straight threads 134, 136 may not be suitable because an NPT thread may cause the retainer 126 to be at an improper position (e.g., a height, a perpendicularity, etc.) relative to the valve body 102, thereby affecting the position of the poppet 118 relative to the valve seat 132 and, thus, a fluid flow rate for a given stroke position of the diaphragm 112. For example, if the retainer 126 is at a lower height relative to the valve body 308 than desired, the diaphragm 112 may have to be stroked a greater distance than necessary to obtain a desired fluid flow rate.

Further, a cleaning process may not be suitable after assembly of the fluid regulator 100 in some instances because a cleaning solution or solvent may not be completely removed from the fluid regulator 100 after cleaning. As a result, the solvent may interact with a process fluid (e.g., oxygen) in operation when the fluid regulator 100 is coupled to a process system.

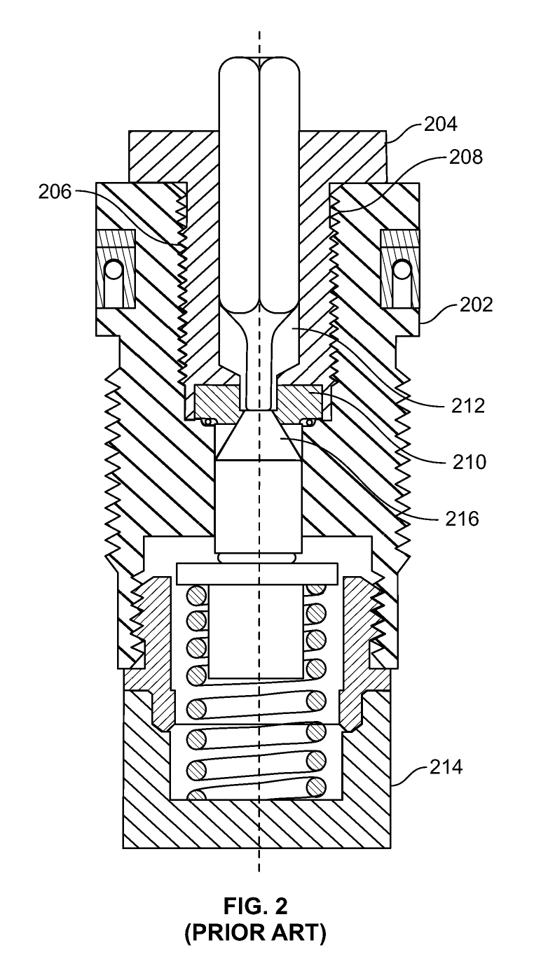

FIG. 2 illustrates a known valve cartridge or apparatus 200 that may be used to implement the fluid regulator 100 of FIG. 1. In this example, the valve apparatus 200 includes a body or housing 202 to threadably couple the valve apparatus 200 to a valve body (e.g., the valve body 102 of the fluid regulator 100 of FIG. 1). Additionally, the valve apparatus 200 includes a cap 204 having external threads 206 that engage internal threads 208 of the body 202 to retain a valve seat 210 within the body 202 of the valve apparatus 200. However, the threads 206 of the body 202 and the threads 208 of the cap 204 are in fluid communication with a fluid flow passageway 212 of the valve apparatus 200. In other words, the threads 206 and 208 are disposed downstream from a filter 214. Thus, debris, contaminate or impurities formed by the threads 206 of the body 202 and the threads 208 (e.g., straight threads) of the cap 204 during assembly may flow within the fluid flow passageway 212 during operation, thereby contaminating downstream components or equipment. Additionally or alternatively, impurities may settle on respective sealing surfaces of the valve seat 210 and/or a poppet 216 of the valve apparatus 200, thereby preventing a substantially tight seal when the poppet 216 engages the valve seat 210 when the valve apparatus 200 is in a closed position. Additionally, such accumulation of impurities may damage the valve seat 210 and/or the poppet 216.

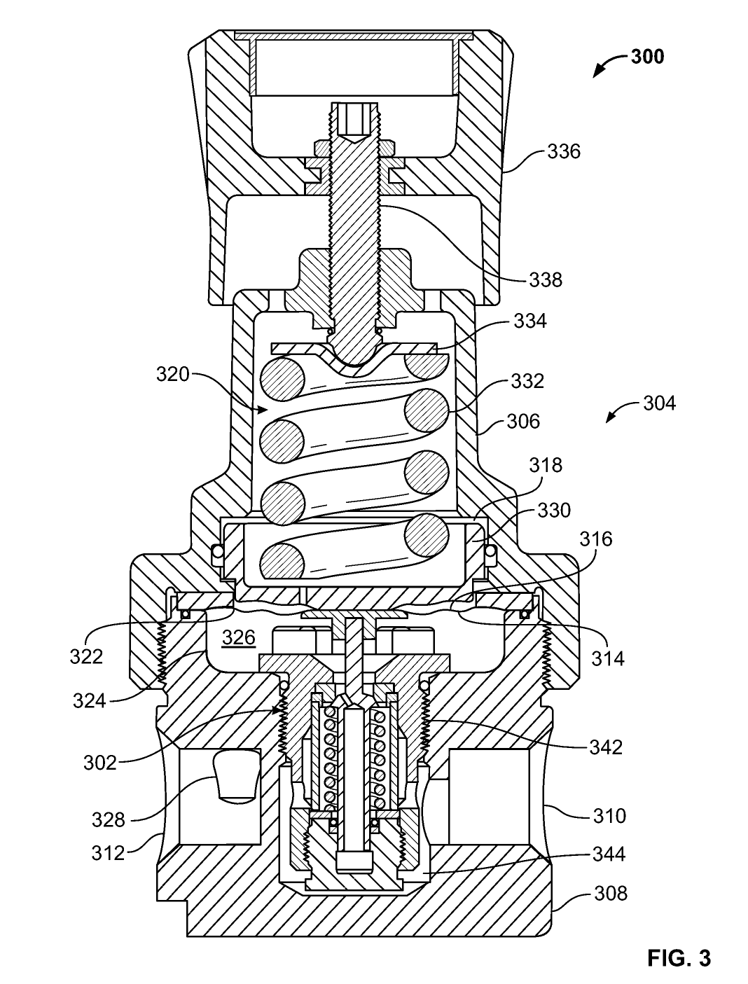

FIG. 3 illustrate an example fluid regulator 300 having a valve cartridge or valve apparatus 302 described herein. Referring to FIG. 3, the example fluid regulator 300 includes a regulator body 304 having an upper body portion or bonnet 306 coupled (e.g., threadably coupled) to a lower body portion or valve body 308. The valve body 308 forms a fluid flow passageway between an inlet 310 and an outlet 312 of the fluid regulator 300. A diaphragm 314 is captured between the valve body 308 and the bonnet 306 so that a first side 316 of the diaphragm 314 and the bonnet 306 define a load chamber 318 to receive a load assembly 320. A second side 322 of the diaphragm 314 and an inner surface 324 of the valve body 308 define a sensing chamber 326. The sensing chamber 326 is fluidly coupled to the outlet 312 via a passage 328 and senses the pressure of the fluid at the outlet 312.

The load assembly 320 is operatively coupled to the diaphragm 314 via a diaphragm plate or back-up plate 330 and provides a reference force or load (e.g., a pre-set force) to the diaphragm 314. In this example, the load assembly 320 includes a biasing element 332 (e.g., a spring) disposed within the load chamber 318 that provides a load to the diaphragm 314 via the diaphragm plate 330. The biasing element 332 seats between the diaphragm plate 330 and a spring button 334 that is operatively coupled to a spring adjustor 336 via a screw 338. The spring adjustor 336 moves the biasing element 332 via the spring button 334 to adjust (e.g., increase or decrease) the amount of a preset force or load that the biasing element 332 exerts on the first side 316 of the diaphragm 314. For example, rotation of the spring adjustor 334 in a first direction (e.g., a clockwise direction) or a second direction (e.g., a counterclockwise direction) varies the amount of compression of the biasing element 332 (e.g., compresses or decompresses the biasing element 332) and, thus, the amount of load exerted on the first side 316 of the diaphragm 314.

To control or modulate fluid flow between the inlet 310 and the outlet 312, the fluid regulator 300 employs the valve apparatus or valve cartridge 302. The valve apparatus 302 of the illustrated example is a subassembly that is disposed within a bore or opening 342 (e.g., a threaded opening) of the valve body 308 that defines an inlet chamber 344 fluidly coupled to the inlet 310. The valve apparatus 302 is operatively coupled to the diaphragm 314 such that the diaphragm 314 causes the valve apparatus 302 to move between an open position to allow fluid flow through the passageway of the fluid regulator 300 and a closed position to restrict fluid flow through the passageway of the fluid regulator 300 based on a pressure differential on opposing of the diaphragm 314 provided by the biasing element 332 and the pressure in the sensing chamber 326.

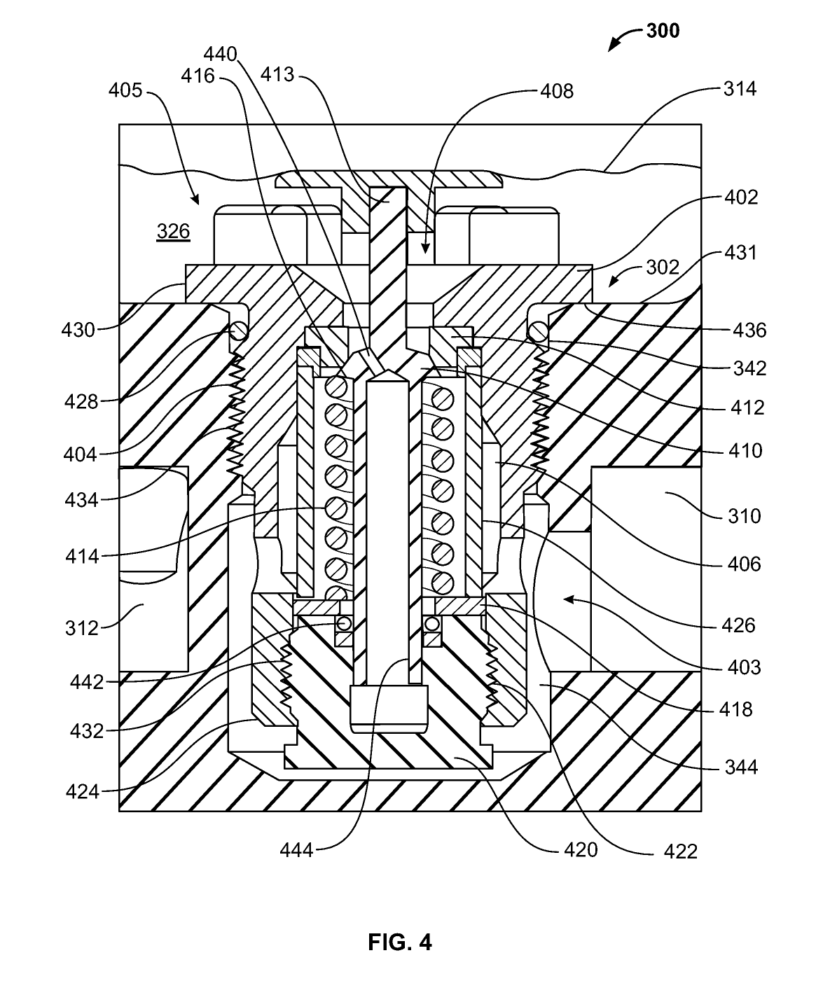

FIG. 4 is an enlarged view of the valve apparatus 302 of FIG. 3. As shown in FIG. 4, the valve apparatus 302 includes a housing or retainer 402. The housing 402 has a cylindrically-shaped body having a threaded portion 404 to threadably couple the valve apparatus 302 to the opening 342 of the valve body 308 of the fluid regulator 300.

The housing 402 includes a cavity or bore 406 to at least partially define the fluid flow passageway when the valve apparatus 302 is coupled to the valve body 308. More specifically, when coupled within the fluid flow passageway of the fluid regulator 300, the valve apparatus 302 defines a high-pressure side 403 of the fluid flow passageway in fluid communication with the inlet 310 and a low-pressure side 405 of the fluid flow passageway in fluid communication with the outlet 312.

A movable valve or flow control assembly 408 is disposed within the bore 406 to control fluid flow between the inlet 310 and the outlet 312. In this example, the flow control assembly 408 includes a poppet 410, a valve seat 412, and a biasing element 414. The biasing element 414 is disposed between a shoulder 416 of the poppet 410 and a spring seat 418 to bias the poppet 410 toward the valve seat 412 (e.g., a closed position). The diaphragm 314 moves relative to (e.g., engages) a stem 413 of the poppet 410 to move the poppet 410 relative to the valve seat 412 to modulate or control fluid flow through the passageway.

To retain the flow control assembly 408 within the bore 406 of the housing 402, the valve apparatus 302 includes a cap 420. The cap 420 includes external threads 422 to threadably couple the cap 420 to an end 424 of the housing 402. In other examples, the cap 420 may be crimped onto the end 424 of the housing 402.

In this example, the valve apparatus 302 also includes a filter or filter cartridge 426 (e.g., a screen) coupled to the housing 402 such that the filter 426 is disposed within the inlet chamber 344. As shown, the filter 426 is disposed between the cap 420 and the valve seat 412 to filter impurities (e.g., debris, contaminates, etc.) in the fluid flowing to the inlet chamber 344 from the inlet 310. Thus, the cap 420 retains the filter 426 within the bore 406 of the housing 402. As shown, the filter 426 is a cylindrically-shaped sintered metal filter that substantially encompasses or surrounds the poppet 410. The filter 426 engages the valve seat 412 to retain the valve seat 412 against the shoulder 416 of the housing 402 to prevent fluid from the inlet chamber 344 from flowing past the valve seat 412.

To provide a seal between the sensing chamber 326 and the inlet chamber 344, the valve apparatus 302 includes a seal 428. The seal 428 (e.g., an O-ring) is disposed between the housing 402 of the valve apparatus 302 and the valve body 308 of the fluid regulator 300. Additionally, the seal 428 is disposed between the sensing chamber 326 and the threads 404 of the housing 402. In particular, the seal 428 is disposed on the low-pressure side 405 of the threads 404 (i.e., above the threads 404 in the orientation of FIGS. 3 and 4) and prevents impurities or debris from flowing between the high-pressure side 403 of the fluid flow passageway to the low-pressure side 405 of the fluid flow passageway via the sensing chamber 326. In other words, the seal 428 is disposed between an outer surface of the housing 402 and an inner surface of the opening 342 of the valve body 308 to prevent impurities adjacent the threads 404 from flowing in the fluid flow passageway via the sensing chamber 326. The opening 342 of the valve body 308 causes the O-ring to collapse or deform when coupled to the opening 342 to provide a relatively fluid tight seal between the valve body 308 and the housing 402.

In the illustrated example, the housing 402 includes a flange 430 to retain the seal 428. Further, the flange 430 provides a positive stop that engages a surface 431 of the valve body 308 to provide a proper position or orientation (e.g., a height, perpendicularity, etc.) of the valve apparatus 302 relative to the valve body 308. Additionally, the threads 404 of the housing 402 and threads 434 of the opening 342 are straight threads so that valve apparatus 302 can be threaded to the opening 342 of the valve body 308 until the flange 430 engages the surface 431 of the valve body 308. Engagement of a surface 436 of the flange 430 with the surface 431 of the valve body 308 provides a proper position (e.g., a height, perpendicularity, etc.) of the valve apparatus 302 relative to the valve body 308. Thus, an NPT thread may not be suitable because such thread may prevent the flange 430 from engaging the surface 431. A proper position or orientation of the valve apparatus 302 provides a predicted flow rate across the orifice 408 for a given stroke position of the diaphragm 314. If the valve apparatus 302 is improperly positioned (e.g., at a height greater than or less than the position shown in FIG. 4), the diaphragm 314 may cause the poppet 410 to move at a distance (e.g., a greater distance, a lesser distance) away from the valve seat 412 that provides a different fluid flow rate across the orifice 408 than a predicted fluid flow rate at a given stroke length of the diaphragm 314 (e.g., a fluid flow rate greater than or less than the predicted fluid flow rate at the give stroke length).

Additionally or alternatively, if the valve apparatus 302 is adjusted too high, the diaphragm 314 may engage the connector stem 413 and provide a pre-load condition to the poppet 410, which may provide a force on the poppet 410 to prevent the poppet 410 from sealingly engaging the valve seat 412 and causing fluid leakage across the valve seat 412. If the valve apparatus 302 is positioned too low (e.g., at a height that is lower than what is shown), the diaphragm 314 has to move or flex a greater amount or distance to move the poppet 410 away from the valve seat 412 to the open position, which may cause the diaphragm 314 to fail to due to stress or fatigue.

Further, the valve apparatus 302 of the illustrated example employs a non-threaded connection on the low-pressure side 405 of the fluid flow passageway to house or contain the flow control assembly 408 within the bore 406. In other words, the valve apparatus 302 of the illustrated example does not include internal threads on the valve apparatus 302 in fluid communication with the low-pressure side 405 that may introduce impurities or debris downstream of the filter 426 and contaminate the fluid flowing through the passageway, and/or cause damage to the valve seat 412 and/or the poppet 410. More specifically, the flow control assembly 408 is retained within the bore 406 of the housing 402 using a non-threaded connection downstream from the filter 426. For example, the poppet 410, the valve seat 412 and the biasing element 414 are held or retained within the bore 406 between the shoulder 416 of the housing 402 and the cap 420 when the cap 420 is threadably coupled to the housing 402. Further, the threads 422 of the cap 420 and threads 432 of the housing 402 are upstream from the filter 426 or adjacent a non-filtered side of the filter 426 and/or in communication with the high-pressure side 403. Thus, the seal 428 and the filter 426 isolate or prevent impurities formed by the threads 422 and 432 during assembly from flowing into the low-pressure side 403 of the passageway. Further, the seal 428 prevents impurities formed between the threads 404 of the valve apparatus 302 and threads 434 of the opening 342 of the valve body 308 during assembly from flowing into the low-pressure side 403 of the fluid flow passageway.

Referring to FIGS. 3 and 4, in operation, the example fluid regulator 300 fluidly couples to, for example, an upstream pressure source providing a relatively high pressure fluid (e.g., a gas) via the inlet 310 and fluidly couples to, for example, a low pressure downstream device or system via the outlet 312. The fluid regulator 300 regulates the outlet pressure of the fluid flowing through the fluid regulator 300 to a desired pressure corresponding to the preset load provided by the adjustable load assembly 320.

To achieve a desired outlet pressure, the adjustor 336 is rotated (e.g., in a clockwise or counterclockwise direction) to increase or decrease the load exerted by the biasing element 332 on the first side 316 of the diaphragm 314. With the reference pressure set, the sensing chamber 326 senses a pressure of the pressurized fluid at the outlet 312 via the passage 328, which causes the diaphragm 314 to move in response to pressure changes in the sensing chamber 326 based on a pressure or force differential provided across the diaphragm 314 by the pressurized fluid in the sensing chamber 326 and the biasing element 332. A pressure differential across the diaphragm 314 causes the poppet 410 to move between a closed position at which the poppet 410 engages (e.g., sealingly engages) the valve seat 412 to restrict fluid flow between the inlet 310 and the outlet 312 and an open position at which the poppet 410 moves away from the valve set 412 to allow fluid flow between the inlet 310 and the outlet 312. The pressurized fluid flows between the inlet 310 and the outlet 312 until the pressures or forces on opposing sides of the diaphragm 314 are balanced.

Impurities (e.g., debris, contaminate or particulate) in the fluid and/or between the threads 404, 422 that may be produced during assembly of the valve apparatus 302 or the fluid regulator 300 flows toward the filter 426, which prevents or substantially restricts passage of impurities, particulate or contaminate into the fluid flow passageway. Also, the seal 428 prevents impurities within the threads 404 and/or the inlet chamber 344 from flowing in the fluid flow passageway via the sensing chamber 326. As a result, the seal 428 and the filter 426 capture or trap impurities upstream from the filter 426 and away from the fluid flow passageway. As a result, impurities in the fluid and/or that may form during assembly of the fluid regulator 300 settle within the inlet chamber 344 or are contained within the high-pressure side 403 of the fluid flow passageway. Additionally, the valve seat 412 and the poppet 410 are protected from impurities because the seal 428 and the filter 426 both prevent impurities from reaching or accumulating on the valve seat 412 and or the poppet 410.

Further, the valve apparatus 302 provides a non-threaded connection in fluid communication with the low-pressure side 405 of the fluid flow passageway. Thus, the valve assembly 302 does not form impurities downstream from the filter 426 when assembling the valve apparatus 302 to the fluid regulator 300.

The valve apparatus 302 of FIGS. 3 and 4 is a balanced valve apparatus. A balanced valve apparatus may be used with larger Cᵥ (relatively high flow rates) and higher process fluid inlet pressures (e.g., 4500 psi). To balance the poppet 410, the poppet 410 includes a fluid flow passage 440 to fluidly couple a void 442 of the poppet 410 between the seat 412 and the cap 420 to the outlet 312. A seal 444 is disposed between the void 442 and the cap 420 to prevent inlet pressure from flowing into the void 442. During operation, the poppet 410 is substantially balanced with the outlet pressure so that the diaphragm 314 does not have to overcome a force of the inlet pressure when moving the poppet 410. Absent the seal, a force provided by the inlet pressure may cause damage to the poppet 410 and/or the valve seat 412.

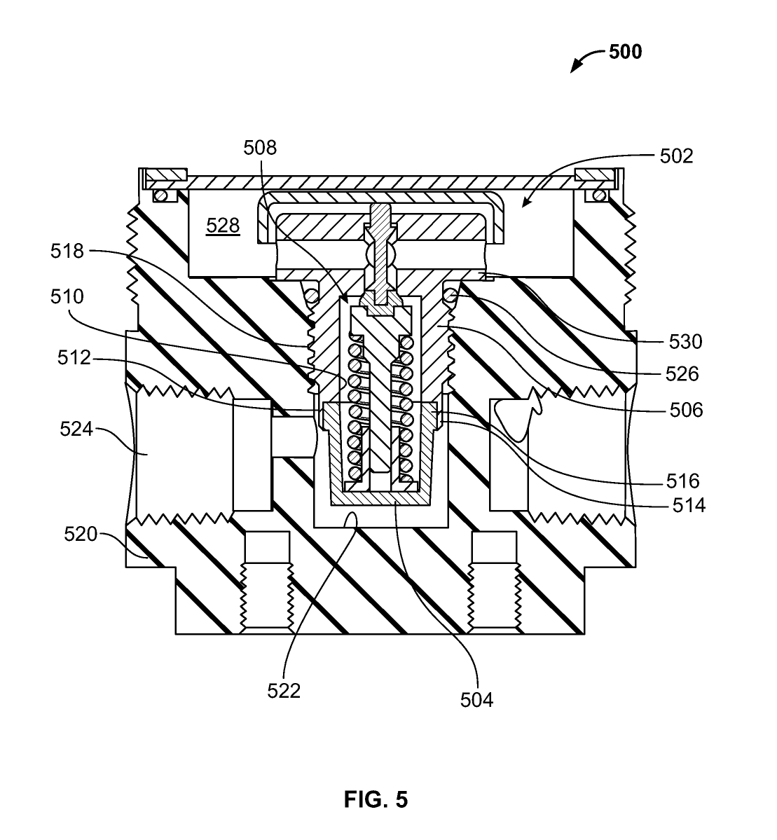

FIG. 5 is a partial view of a fluid regulator 500 having another example valve apparatus or valve cartridge 502 described herein. In this example, the valve apparatus 502 includes a filter 504 that is coupled to a housing 506 of the valve apparatus 502 to retain a flow control assembly 508 within a bore 510 of the housing 506. Thus, in contrast to the valve apparatus 302 of FIGS. 3 and 4, the filter 504 of the example valve apparatus 502 retains the flow control assembly 508 within the bore 510 of the housing 506 to eliminate a threaded connection between the cap 420 and the housing 402. In this example, the filter 504 is coupled to an end 512 of the housing 506 via press fit, snap-fit, interference fit, etc. More specifically, the end 512 of the housing 506 includes tabs or fingers 514 to receive an enlarged portion 516 of the filter 504. Unlike the valve apparatus 302 of FIG. 4, the valve apparatus 502 of FIG. 5 is not balanced. In particular, the valve apparatus 502 may be used with relatively low Cᵥ (low flow) characteristics and relatively lower process fluid inlet pressures.

Similar to the valve apparatus 302 of FIG. 3, the valve apparatus 502 is a subassembly that includes external threads 518 to threadably couple to a valve body 520 of the fluid regulator 500. In particular, in this example, the housing 506 is a cylindrical body having the external threads 518. The filter 504 is disposed in a bore or inlet chamber 522 in communication with an inlet 524 of the valve body 520 to prevent impurities from flowing within the bore 510 or a fluid flow passageway during operation. A seal 526 is disposed between the threads 518 and a sensing chamber 528 to prevent impurities between the filter 504 and the seal 526 (e.g. in the inlet chamber 522) from flowing in the fluid flow passageway via the sensing chamber 528. The housing 506 of the illustrated example includes a flange 530 to retain the seal between the housing 506 and the valve body 520.

Further, the valve apparatus 502 includes a non-threaded connection downstream from the filter 504. Thus, the filter 504 and the seal 526 trap or contain impurities upstream of the filter 504. In operation, the filter 504 and the seal 526 isolate impurities (e.g., produced by the external threads 518) upstream from the filter 504 and prevent impurities from flowing in the fluid flow passageway and/or accumulating on the fluid control apparatus 508.

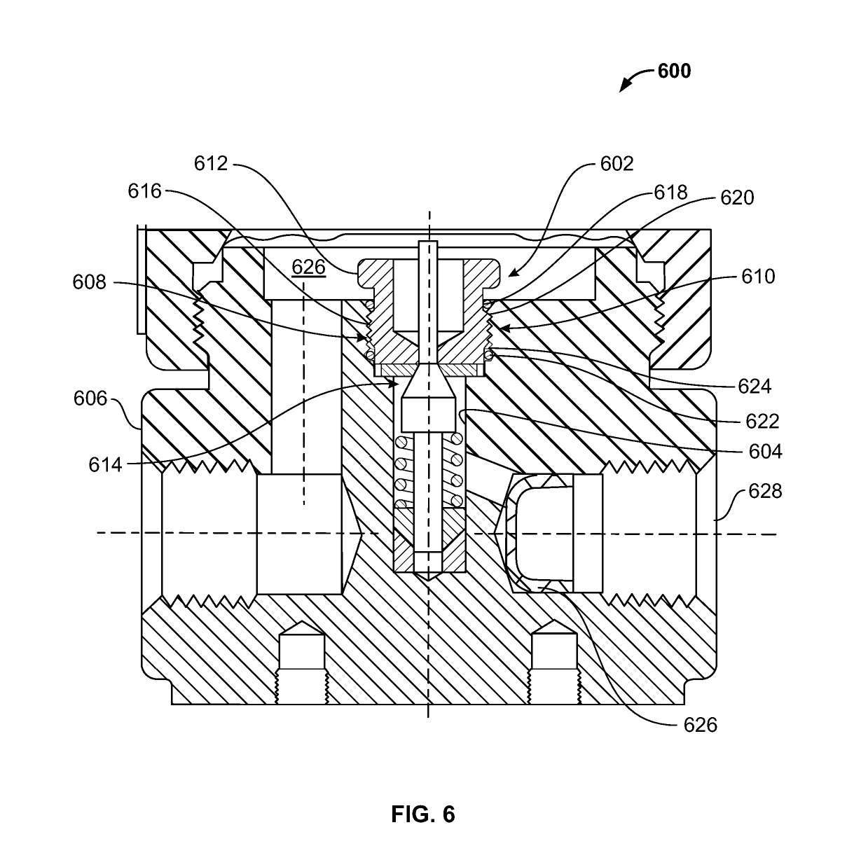

FIG. 6 is a partial view of a fluid regulator 600 having another example valve apparatus 602 described herein. In this example, the valve apparatus 602 is disposed within a bore or inlet chamber 604 of a valve body 606 of the fluid regulator 600. In contrast to the valve apparatus 302 and 502 of FIGS. 3-5, the valve apparatus 602 employs a dual seal apparatus 608 to capture or contain impurities (e.g., contaminate debris or particulate) within threads 610 of the valve apparatus 602.

Referring to FIG. 6, the valve apparatus 602 includes a retaining cap 612 to retain a flow control apparatus 614 in the bore 604 of the valve body 606. The cap 612 has a cylindrical body with external threads 616. A first seal 618 is disposed adjacent a first end 620 of the threads 616, and a second seal 622 is disposed adjacent a second end 624 of the threads 616. In other words, the first seal 618 is disposed between the threads 616 and a low-pressure side or sensing chamber 626 and the second seal 622 is disposed between the threads 616 and a high pressure side or inlet chamber 604 of the valve body 606. In this manner, the first and second seals 618 and 622 capture or contain impurities that may form during assembly when the cap 612 is threadably coupled to the bore 604. In operation, the seals 618 and 622 trap or contain impurities or debris to prevent impurities or debris from flowing in a fluid flow passageway of the fluid regulator 600. Further, a filter 626 may be disposed within an inlet 628 to filter impurities in the fluid upstream from the inlet 628.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A valve assembly for use with a fluid regulator comprising:
a housing disposed within a fluid flow passageway of the fluid regulator to define a low-pressure side of the fluid flow passageway and a high-pressure side of the fluid flow passageway, the housing having a bore that at least partially defines the fluid flow passageway when coupled to the fluid regulator, the housing having a movable valve assembly disposed within the bore via a non-threaded connection in fluid communication with the low-pressure side of the fluid flow passageway and external threads to threadably couple the housing to an opening of the fluid regulator; and
a seal system to prevent impurities from flowing between the high-pressure side of the fluid flow passageway and the low-pressure side of the fluid flow passageway.

2. A valve assembly of claim 1, wherein the movable valve assembly is to control fluid flow between the low-pressure side and the high-pressure side of the fluid flow passageway, wherein the movable valve assembly comprises a valve seat, a poppet and a biasing element disposed within the bore of the housing.

3. A valve assembly of claim 2, further comprising a retaining cap removably coupled to the housing to retain the poppet, the valve seat and the biasing element within the bore of the housing.

4. A valve assembly of claim 1, wherein the seal system comprises a seal and a filter to trap impurities within an inlet chamber defined by the opening of the fluid regulator.

5. A valve assembly of claim 4, wherein the seal is disposed adjacent an outer portion of the housing between the external threads and a sensing chamber of the fluid regulator to prevent impurities from flowing in the fluid flow passageway via the sensing chamber.

6. A valve assembly of claim 4, wherein the filter is coupled to the housing and disposed within the high-pressure side of the fluid flow passageway between the inlet and the bore such that the seal and the filter trap impurities upstream of the filter to prevent contamination of a process fluid downstream of the filter.

7. A valve assembly of claim 6, wherein the filter is disposed between the valve seat and the retaining cap and substantially surrounds the poppet.

8. A valve assembly of claim 1, wherein the seal comprises an O-ring disposed adjacent and end of the external threads.

9. A valve assembly of claim 1, wherein the seal system comprises a first O-ring disposed adjacent an end of the external threads and a second O-ring disposed adjacent another end of the external threads.

10. A fluid regulator, comprising:
a valve body having a threaded opening that at least partially defines a fluid flow passageway between an inlet and an outlet;
a valve cartridge having a housing that includes external threads to removably coupled valve cartridge to the threaded opening of the valve body, the valve cartridge having a filter coupled to the housing, the housing having a bore to receive a flow control assembly, wherein the flow control assembly is coupled to the housing via a non-threaded connection downstream from the filter; and
a seal coupled to the housing of the valve cartridge, the seal being positioned between the external threads of the valve cartridge and a sensing chamber of the fluid regulator to prevent impurities from contaminating a process fluid downstream of the filter, wherein the seal and the filter isolate impurities within the opening of the fluid regulator upstream from the filter.

11. A fluid regulator of claim 10, wherein the valve cartridge includes a cylindrical body portion and a flange portion.

12. A fluid regulator of claim 10, wherein the flow control assembly comprises a valve seat, a poppet and a biasing element.

13. A fluid regulator of claim 10, wherein the valve cartridge includes a cap to retain the poppet, the valve seat and the biasing element within the bore of the housing.

14. A fluid regulator of claim 13, wherein the cap includes threads to threadably couple to an end of the housing, wherein the threads of the cap are upstream from the filter.

15. A fluid regulator of claim 14, wherein the filter is disposed within the bore between the valve seat and the cap such that the filter surrounds the poppet between the valve seat and the cap, wherein the filter engages the valve seat to retain the valve seat within the bore.

16. A fluid regulator of claim 10, wherein the filter is coupled to an end of the housing to retain the poppet, the valve seat and the biasing element within the bore of the housing.

17. A fluid regulator of claim 10, further comprising a second seal disposed between the external threads of the valve cartridge and an inlet chamber of the fluid regulator.

18. A fluid regulator of claim 10, wherein the filter and the seal hold impurities within an inlet chamber in fluid communication with the inlet between the seal, the filter and an inner surface of the opening of the valve body.

19. A valve assembly for use with a fluid regulator, comprising:
a cylindrical body having external threads to removably couple the valve assembly to a fluid regulator, and a bore between a first end and a second end of the body to at least partially define a fluid flow passageway of the fluid regulator;
a valve seat disposed within the bore such that the valve seat engages a shoulder of the body;
a poppet disposed within the bore and biased toward the valve seat via a biasing element;
a retainer coupled to the first end of the body to retain the valve seat, the poppet, and the biasing element within the bore; and
a seal disposed between external threads of the body and a sensing chamber of the fluid regulator to prevent impurities from flowing within the fluid flow passageway via a sensing chamber of the fluid regulator.

20. A valve assembly of claim 19, further comprising a filter coupled to the body between the bore and an inlet of the fluid regulator, wherein the filter and the seal trap impurities upstream from the filter.

21. A valve assembly of claim 20, wherein the retainer comprises a cap threadably coupled to the body, wherein the filter is disposed between the valve seat and the cap.

22. A valve assembly of claim 19, wherein the seal comprises a first O-ring disposed adjacent an end of the external threads and a second O-ring disposed adjacent another end of the external threads.
